(19) United States
(12) Patent Application Publication
(10) Pub. No.: US 2006/0036697 A1
(43) Pub. Date: Feb. 16, 2006

(54) Email system and method thereof

(76) Inventors: Jun-Liang Lin, Fongyuan City (TW); Chien-Chung Huang, Taichung City (TW); Dah-Chung Chen, Taoyuan Hsien (TW); Teng-Hsiang Hsu, Hsinchu (TW); Shih-Wei Chen, Hsinchu (TW); Chih-Yang Wang, Hsinchu Hsien (TW)

Correspondence Address: THOMAS, KAYDEN, HOSTEMEYER & RISLEY LLP, 100 GALLERIA PARKWAY, SUITE 1750, ATLANTA, GA, 30339, US

(21) Appl. No.: 10/918,862

(22) Filed: Aug. 16, 2004

(51) Int. Cl. G06F 15/16

(52) U.S. Cl. 709/206

(57) ABSTRACT

An email system and method thereof. The system includes at least a mail agent to receive at least one email message with a flag. The mail agent assesses the flag, and performs a predefined process including storing mail content of the email message in a database, generating a new email message comprising a link to the mail content of the email message in the database, and forwarding the new email message to recipients of the email message if the flag is a predefined value.

### BACKGROUND

The present invention relates to an email system and method thereof, and particularly to an email system that saves disc space and raises performance of the email system by automatically generating a new email message with a link to the content of the original email message.

With the rise in communicating messages via a network, email has become a daily routine for most people. In enterprise email systems, email messages are delivered regardless of size. If a user sends a 10 MB email message to 100 recipients, that 10 MB is copied to 100 email messages, and occupies about 1000 MB of system storage resources. Additionally, since the mailbox of a typical user has a predefined quota, the large email messages may cause the mailbox to exceed the quota, at which that the user cannot send or receive email messages. Further, the delivery of large email messages may also cause the performance of the email system to suffer, as the same email message stored in different recipient mailboxes wastes system resources.

### SUMMARY

The present invention is proposed to solve the aforementioned issues.

Accordingly, it is an object of the present invention to provide an email system and method that saves disc space and raises performance of the email system.

To achieve the above object, the present invention provides an email system and method thereof. The system includes a mail agent to receive at least one email message with a flag. The mail agent assesses the flag, and performs a predefined process including storing mail content of the email message to a database, generating a new email message comprising a link to the mail content of the email message in the database, and forwarding the new email message to recipients of the email message if the flag is a predefined value.

The mail agent further checks the size of the email content, and disables the predefined process if the size is not greater than a predetermined size. The mail agent further checks the number of recipients, and disables the predefined process if the number is not greater than a predetermined number. The mail agent further determines whether the respective recipient is internal or external to the email system, and disables the predefined process by forwarding the email message to the recipient directly if the recipient is external.

The system further includes an access unit to receive an access authority setting to the mail content from the mail agent, and display the mail content to the recipients via linking of the link in the new email message.

The system further includes a management unit to receive an expiration date setting to the mail content from the mail agent, inform recipients after the expiration date, and delete the mail content after a buffer time subsequent to the expiration date.

According to another embodiment of the present invention, an email method is provided. First, at least one email message with a flag is received. The flag is then assessed, and a predefined process including storing mail content of the email message to a database, generating a new email message comprising a link to the mail content of the email message in the database, and forwarding the new email message to recipients of the email message is performed if the flag is a predefined value.

The predefined process is further disabled if the size of the mail content is not greater than a predetermined size, the number of the recipients is not greater than a predetermined number, or the respective recipient is external to the email system.

Further, an access authority setting to the mail content is received, and the mail content is displayed to the recipients via linking of the link in the new email message. Additionally, an expiration date setting of the mail content is received, the recipients after the expiration date is recorded and informed, and the mail content after a buffer time subsequent to the expiration date is deleted.

The above-mentioned method may take the form of program code embodied in a tangible media. When the program code is loaded into and executed by a machine, the machine becomes an apparatus for practicing the invention.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 is a schematic diagram of the overview of the present invention;

FIG. 2 is a schematic diagram of the architecture of a mail server of the email system according to the present invention;

FIG. 3 is a flowchart showing the process of a mail agent of the email system according to the present invention;

FIG. 4 is a flowchart showing the process of an access unit of the email system according to the present invention;

FIG. 5 is a flowchart showing the process of a management unit of the email system according to the present invention; and

FIG. 6 is a schematic diagram of a storage medium for storing a computer program providing the email method.

### DESCRIPTION

The present invention provides a system and method overcoming conventional email problems.

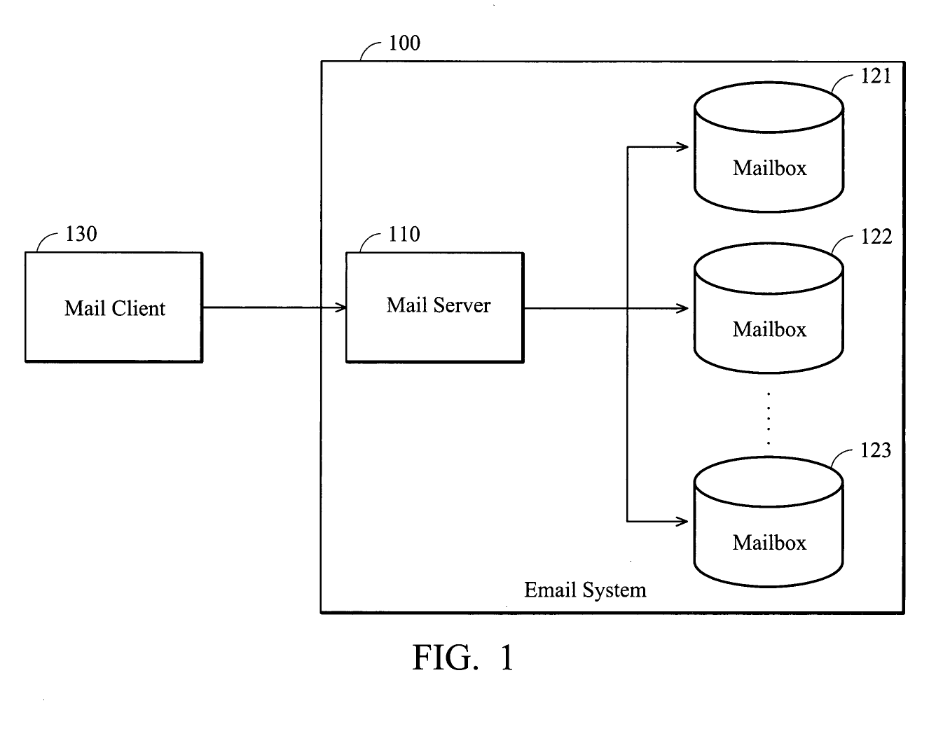

FIG. 1 illustrates the overview of the present invention. The email system 100 includes a mail server 110 and a plurality of mailboxes 121, 122 and 123. The email system 100 receives email messages from at least one mail client 120, and forwards the received email messages to one or more mailboxes of corresponding recipients.

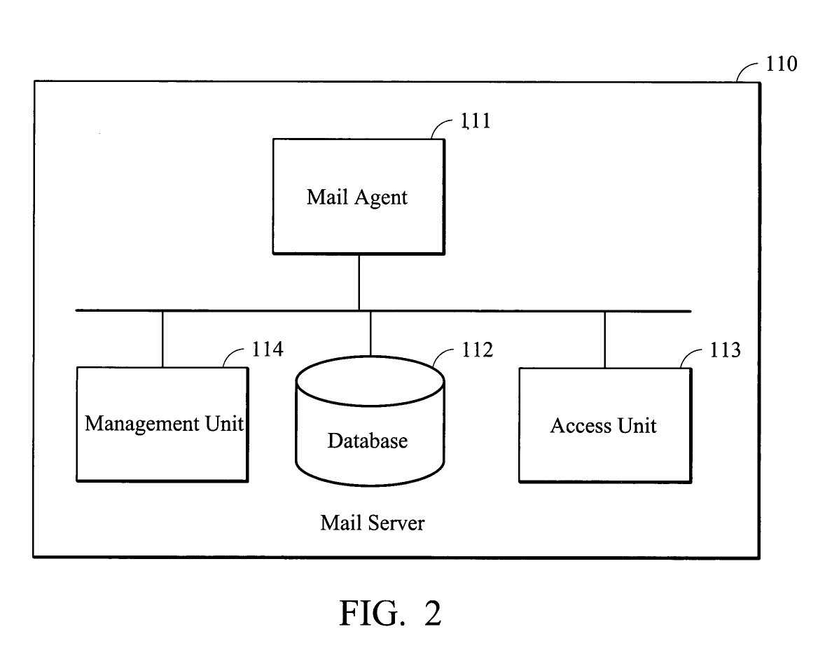

FIG. 2 illustrates the architecture of the mail server 110 of the email system 100 according to the present invention. As shown in FIG. 2, the mail server 110 includes a mail agent 111, a database 112, an access unit 113 and a management unit 114. The mail agent 111 determines whether a predefined process of the present invention should be performed, and performs related operations accordingly. The database 112 stores mail content of email messages as directed by the mail agent 111. The access unit 113 checks the access authority of the respective recipient, and displays mail content to the respective recipient. The management unit 114 deletes mail content after an expiration date. The processes of the mail agent 111, access unit 113 and management unit 114 are described as follows.

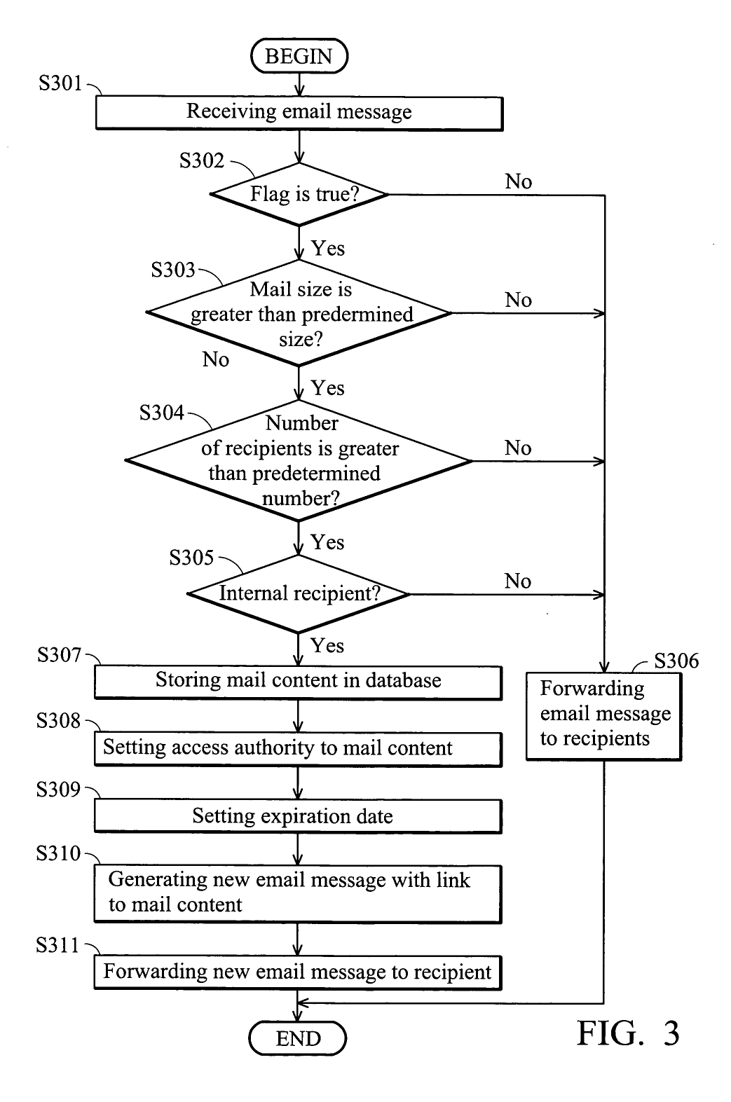

FIG. 3 shows the process of the mail agent 111 according to the present invention.

First, in step S301, the mail agent 111 receives at least one email message with a flag. It is noted that the flag determines whether to perform the email method of the present invention. In step S302, the mail agent assesses the flag. If the flag is not true (No in step S302), in step S306, the mail agent 111 directly forwards the email message to corresponding recipients. If yes (Yes in step S302), in step S303, the mail agent 111 checks the size of mail content of the email message.

If the size is not greater than a predetermined size (No in step S303), in step S306, the mail agent 111 directly forwards the email message to corresponding recipients. If yes (Yes in step S303), in step S304, the mail agent 111 checks the number of recipients of the email message. If the number is not greater than a predetermined number (No in step S304), in step S306, the mail agent 111 directly forwards the email message to corresponding recipients. If yes (Yes in step S304), in step S305, the mail agent 111 determines whether the respective recipient is internal or external to the email system 100, that is the respective recipient is determined as an intranet or internet user. It is understood that the mail agent 111 checks whether the respective recipient is recorded in an address book (not shown) of the email system 100 to determine if the respective recipient is internal or external.

If the recipient is external (No in step S305), in step S306, the mail agent 111 directly forwards the email message to corresponding recipients. If the recipient is internal (Yes in step S305), the flow goes to step S307. It is understood that if one email message is sent to both internal and external recipients, the email message corresponding to external recipients should be forwarded directly, and the email message corresponding to internal recipients should be handled as follows.

In step S307, the mail agent 111 stores the mail content of the email message in the database 112. Then, in step S308, the mail agent 111 sends an access authority setting to the mail content to the access unit 113, such that only the designated recipients can access the mail content via the access unit 113. Thereafter, in step S309, the mail agent 111 sends an expiration date setting to the mail content to the management unit 114. It is noted that the expiration date may be a system predetermined value or set by the mail client 130 and received with the email message, such that the management unit 114 can manage the mail content in the database 112 accordingly. Then, in step S310, the mail agent 111 generates a new email message with a link to the mail content in the database 112, and in step S311, forwards the new email message to internal recipients of the email message.

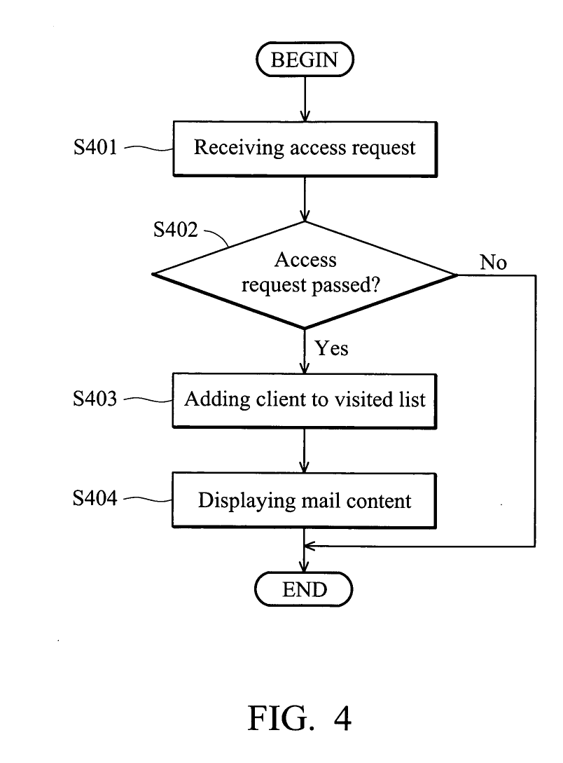

FIG. 4 shows the process of the access unit 113 according to the present invention.

First, in step S401, the access unit 113 receives an access request for specific mail content from at least one client. Then, in step S402, access unit 113 checks the access authority of the client to the mail content. If the access authority does not pass (No in step S402), the access request is denied and the procedure is complete. Otherwise (Yes in step S402), in step S403, the client is added to a visited list (not shown) corresponding to the mail content, and in step S404, the mail content is displayed.

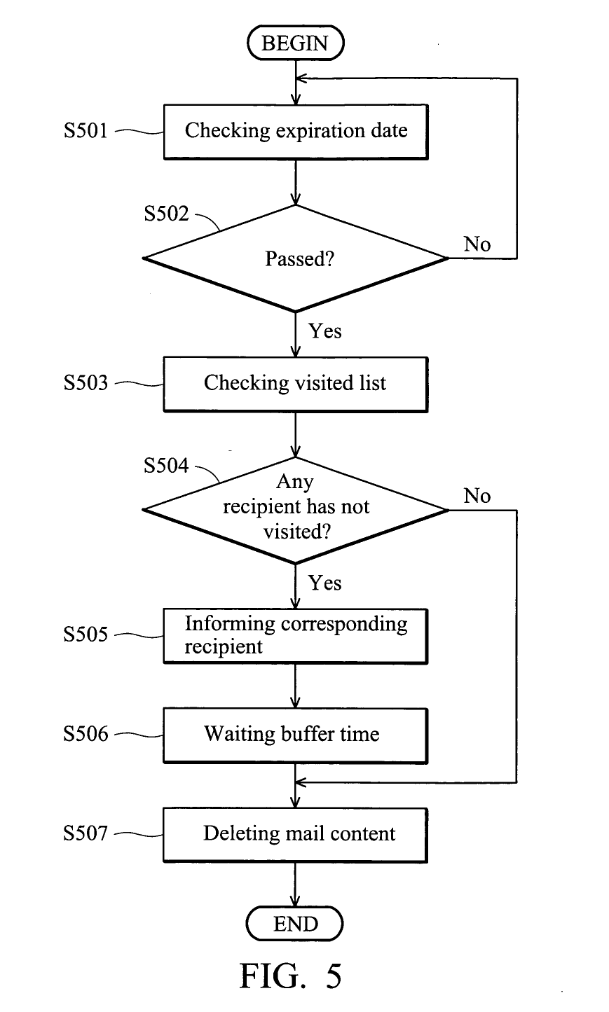

FIG. 5 shows the process of the management unit 114 according to the present invention.

First, in step S501, the management unit 114 checks the expiration date of the mail content of one email message. If the expiration date does not pass, the flow remains at step S501. If yes (Yes in step S502), in step S503, the management unit 114 checks the visited list corresponding to the mail list. If all of the recipients of the email message had watched or accessed the mail content (No in step S504), in step S507, the management unit 114 deletes the mail content in the database 112. If any recipient of the email message has not accessed the mail content (Yes in step S504), in step S505, the management unit 114 informs the recipients that have not accessed the mail content via the mail server 110, and in step S506, waits a buffer time. After the buffer time has passed, in step S507, the management unit 114 deletes the mail content in the database 112.

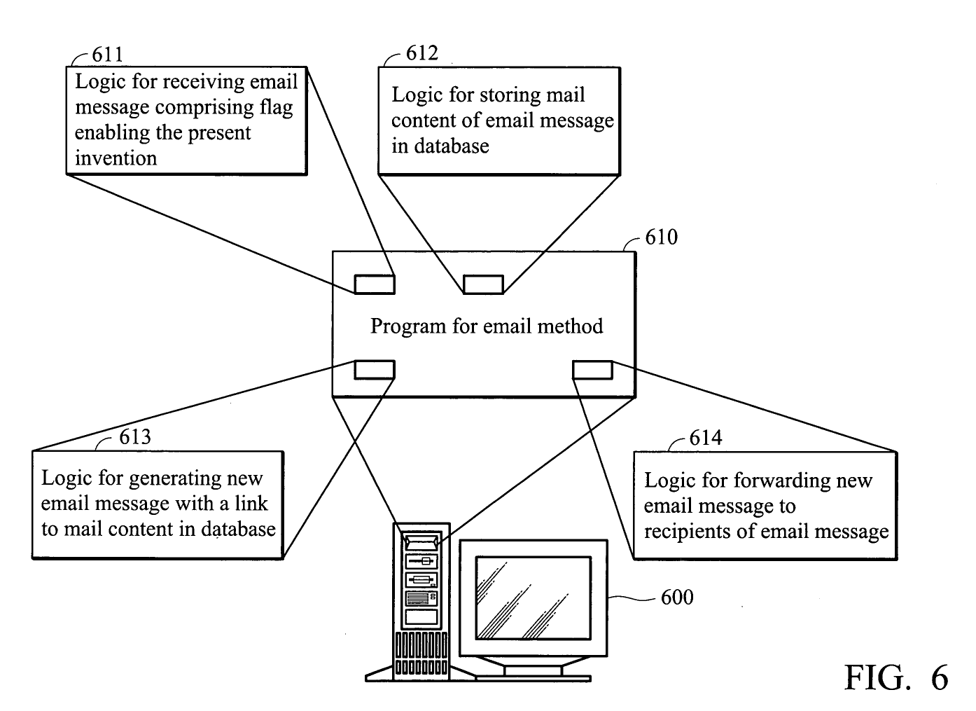

FIG. 6 is a schematic diagram of a storage medium for storing a computer program providing the email method according to the present invention. The computer program product comprises a storage medium 610 having computer readable program codes embodied in the medium for use in a computer system 600, the computer readable program codes comprising at least a computer readable program code 611 for receiving at least one email message comprising at least a flag enabling the present invention, a computer readable program code 612 for storing mail content of the email message in a database, a computer readable program code 613 for generating a new email message with a link to the mail content of the email message in the database, and a computer readable program code 614 for forwarding the new email message to recipients of the email message.

The present invention thus provides an email system and method that automatically generates a new email message with a link to content of the original email message, thereby saving disc space and increasing overall performance of the email system.

The method and system of the present invention, or certain aspects or portions thereof, may take the form of program code (i.e., executable instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The method and systems of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to application specific logic circuits.

Although the present invention has been described in its preferred embodiments, it is not intended to limit the invention to the precise embodiments disclosed herein. Those skilled in this technology can still make various alterations and modifications without departing from the scope and spirit of this invention. Therefore, the scope of the present invention shall be defined and protected by the following claims and their equivalents.

What is claimed is:

1. An email system, comprising:
a mail agent to receive at least one email message comprising at least a flag, assess the flag, and perform a predefined process including storing mail content of the email message to a database, generating a new email message comprising a link to the mail content of the email message in the database, and forwarding the new email message to a recipient of the email message if the flag is a predefined value.

2. The system of claim 1 wherein the mail agent further checks the size of the mail content, and disables the predefined process if the size is not greater than a predetermined size.

3. The system of claim 1 wherein when there are more than one recipient, the mail agent further checks the number of the recipients, and disables the predefined process if the number is not greater than a predetermined number.

4. The system of claim 1 wherein the mail agent further determines whether the recipient is internal or external to the email system, and disables the predefined process by forwarding the email message to the recipient directly if the recipient is external.

5. The system of claim 1 further comprising an access unit to receive an access authority setting, and display the mail content to the recipient via linking of the link in the new email message.

6. The system of claim 5 wherein the access unit further records the recipient when the recipient accesses the mail content.

7. The system of claim 6 further comprising a management unit to receive an expiration date setting, inform the recipient if the recipient has not accessed the mail content after the expiration date, and delete the mail content after a buffer time subsequent to the expiration date.

8. The system of claim 1 further comprising a management unit to receive an expiration date setting, and delete the mail content after the expiration date.

9. The system of claim 7 wherein the expiration date is sent along with the email message.

10. The system of claim 8 wherein the expiration date is sent along with the email message.

11. The system of claim 4 wherein the mail agent checks whether the respective recipient is recorded in an address book of the email system to determine if the respective recipient is internal or external.

12. An email method, comprising the steps of:
receiving at least one email message comprising at least a flag;
assessing the flag; and
performing a predefined process including storing mail content of the email message to a database, generating a new email message comprising a link of the mail content of the email message in the database, and forwarding the new email message to a recipient of the email message if the flag is a predefined value.

13. The method of claim 12 further comprising checking the size of the mail content, and disabling the predefined process if the size is not greater than a predetermined size.

14. The method of claim 12 further comprising: when there are more than one recipient, checking the number of the recipients, and disabling the predefined process if the number is not greater than a predetermined number.

15. The method of claim 12 further comprising determining whether the recipient is internal or external, and disabling the predefined process by forwarding the email message to the recipient directly if the recipient is external.

16. The method of claim 12 further comprising receiving an access authority setting, and displaying the mail content to the recipient via linking of the link in the new email message.

17. The method of claim 16 further comprising recording the recipient when the recipient accesses the mail content.

18. The method of claim 17 further comprising receiving an expiration date setting, informing the recipient if the recipient has not accessed the mail content after the expiration date, and deleting the mail content after a buffer time subsequent to the expiration date.

19. The method of claim 12 further comprising receiving an expiration date setting, and deleting the mail content after the expiration date.

20. The method of claim 18 wherein the expiration date is sent along with the email message.

21. The method of claim 19 wherein the expiration date is sent along with the email message.

22. The method of claim 15 further comprising checking whether the recipient is recorded in an address book to determine if the respective recipient is internal or external.

23. A machine-readable storage medium storing a computer program which, when executed, directs a computer to perform an email method, comprising the steps of:
receiving at least one email message comprising at least a flag;
assessing the flag; and
performing a predefined process including storing mail content of the email message in a database, generating a new email message comprising a link to the mail content of the email message in the database, and forwarding the new email message to a recipient of the email message if the flag is a predefined value.

24. The storage medium of claim 23 further comprising checking the size of the mail content, and disabling the predefined process if the size is not greater than a predetermined size.

25. The storage medium of claim 23 further comprising: when there are more than one recipient, checking the number of the recipients, and disabling the predefined process if the number is not greater than a predetermined number.

26. The storage medium of claim 23 further comprising determining whether the recipient is internal or external, and disabling the predefined process by forwarding the email message to the recipient directly if the recipient is external.

27. The storage medium of claim 23 further comprising receiving an access authority setting, and displaying the mail content to the recipient via linking of the link in the new email message.

28. The storage medium of claim 27 further comprising recording the recipient when the recipient accesses the mail content.

29. The storage medium of claim 28 further comprising receiving an expiration date setting, informing the recipient if the recipient has not accessed the mail content after the expiration date, and deleting the mail content after a buffer time subsequent to the expiration date.

30. The storage medium of claim 23 further comprising receiving an expiration date setting, and deleting the mail content after the expiration date.

31. The storage medium of claim 29 wherein the expiration date is sent along with the new email message.

32. The storage medium of claim 30 wherein the expiration date is sent along with the email message.

33. The storage medium of claim 26 further comprising checking whether the recipient is recorded in an address book to determine if the recipient is internal or external.
